(19) United States
(12) Patent Application Publication
(10) Pub. No.: US 2010/0107472 A1
(43) Pub. Date: May 6, 2010

(54) Insect Trap

(76) Inventor: Anthony Joseph Kennedy, New South Wales (AU)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/442,965

(22) PCT Filed: Aug. 9, 2007
(86) PCT No.: PCT/AU2007/001119

§ 371 Date: Dec. 28, 2009

(30) Foreign Application Priority Data
Sep. 28, 2006 (AU) 2006905354
Feb. 22, 2007 (AU) 2007900890

(51) Int. Cl. A01M 1/10

(52) U.S. Cl. 43/121

(57) ABSTRACT

An insect trap (300) includes a container (301) adapted to be supported between a pair of racks in a bee hive, the trap cover having one or more apertures (312) adapted to permit beetles to crawl into the trap. The cover can project beyond the edges of the container to support the trap between the racks. The trap can contain oil to help prevent the beetle from escaping from the trap.

### FIELD OF THE INVENTION

This invention relates to an insect trap.

The invention is particularly suited for trapping the small hive beetle.

### BACKGROUND OF THE INVENTION

The small hive beetle has become a major pest in countries which use European bees for commercial honey production as these bees have not developed defences against this pest which originated in South Africa. The beetle lava causes damage to the hive in destroying comb and the brood and leaving the honey unfit for human consumption. Heavy infestation can cause the bees to abandon the hive.

US2006141904 describes a bait for small hive beetle which is used in a floor mounted trap.

### SUMMARY OF THE INVENTION

An embodiment of the invention provides a trap which is adapted to be supported between a pair of frames.

The trap can be in the form of a container closed at the bottom, sides and end walls.

The frame can have one or more apertures adapted to permit a beetle to enter trap.

The container is adapted to be partially filled with a fluid.

Preferably the fluid is a food grade oil, such as canola oil or other suitable oil.

The oil can be filled into the container to cover the bottom of the container to a depth such that a beetle will be at least partially immersed.

One or more baffles can be provided in the base of the container to divide the oil into two or more sections.

One or more apertures to provide an entry to the container can be provided in the top or upper part of a side wall.

Preferably the apertures are sufficiently small to deter the entry of bees to the container.

In one embodiment, the container is an elongated U-shaped container.

A removable cover can be adapted to fit over the open upper end of the container.

The cover can include one or more apertures.

The cover can include an plurality of holes.

The cover can be formed of an array of miniature slats connected to a support member.

The cover can be a snap-fit with the container.

The container can include a protruding lip at either end.

The cover can include a mating recess adapted to form a snap-fit attachment with the protruding lips of the container.

The sides of the container can be sufficiently flexible to permit them to be pressed inwards to disengage the snap-fit attachment.

The invention also provides a snap-action engagement mechanism including a pair of spaced apart substantially parallel opposed lips and a pair of spaced apart mating oppose recesses, at least one pair of the lips or recesses being resiliently mounted and adapted to create opposing latching forces when engaged with the mating pair of recesses or lips.

The lips can be formed on a first member, and the recesses can be formed on a second member, the first member being compressible proximate the lips to disengage the snap-action connexion.

The snap action mechanism can include a tapered member adapted to interact with the compressed sides of the first member to produce a separating force to disengage the snap-action connexion.

### BRIEF DESCRIPTION OF THE DRAWINGS

An embodiment or embodiments of the present invention will now be described, by way of example only, with reference to the accompanying drawings, in which:

FIG. 1 is a schematic illustration of a trap according to an embodiment of the invention;

FIG. 2 is a schematic illustration of a cover adapted to fit a trap as shown in FIG. 1;

FIG. 3 is a schematic illustration of a trap and cover;

FIG. 4 is a partial underside view of the cover;

FIG. 5 shows an alternative cover;

FIG. 6 shows an alternative cross-section of a trap supported between racks;

FIG. 7 shows a further alternative section for a trap;

FIG. 8 illustrates a trap inserted in a hive.

### DETAILED DESCRIPTION OF THE EMBODIMENT OR EMBODIMENTS

The invention will be described with reference to the embodiments shown in the drawings.

The beetle are harried by the bees and also prefer a dark environment. The inventor has observed that, in hives having a mat placed over the tops of the frames to prevent the bees from building burr comb, the beetles congregate on the tops of the frames under the mats.

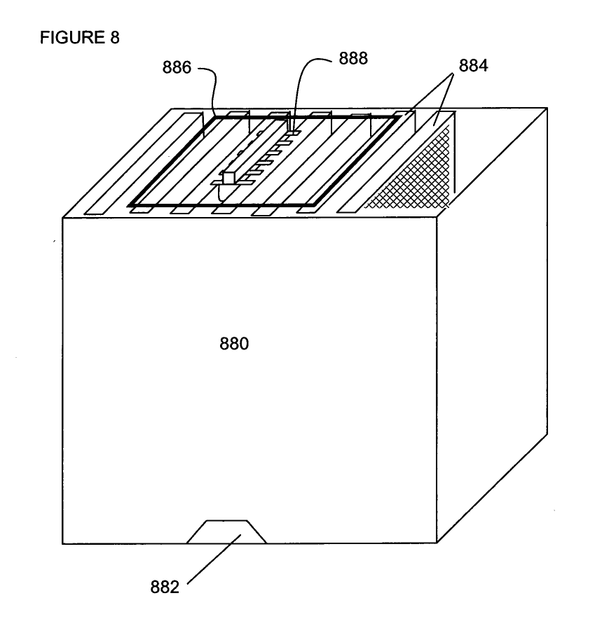

An embodiment of the invention provides a trap which is adapted to be supported between a pair of frames as shown in FIG. 8.

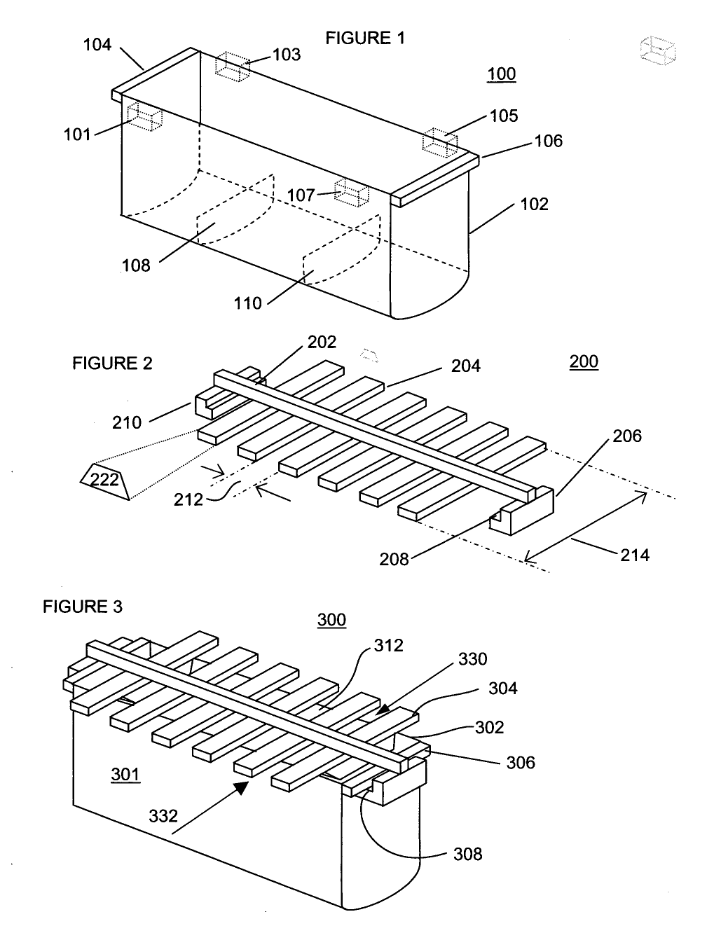

The trap can be in the form of a container closed on the bottom, sides and end walls as shown in FIGS. 1 & 3.

The trap can have one or more apertures adapted to permit a beetle to enter trap as shown in FIG. 3.

The container can be adapted to be partially filled with a fluid as shown in FIG. 1. Preferably the fluid is a food grade oil, such as canola oil or other suitable oil. The oil can be filled into the container to cover the bottom of the container to a depth such that a beetle will be at least partially immersed. One or more baffles 108, 110 can be provided in the base of the container to divide the oil into two or more sections.

The trap can include one or more apertures in the top or upper part of a side wall of the trap to provide an entry to the container. Preferably the apertures are sufficiently small to deter the entry of bees to the container.

In one embodiment, the container is an elongated U-shaped container.

A removable cover (FIG. 2) can be adapted to fit over the open upper end of the container. The cover can include one or more apertures.

The cover can include an plurality of holes.

Alternatively, the cover can be formed of an array of miniature slats connected to a support member.

The cover can be a snap-fit with the container. The container can include a protruding lip at either end. The cover can include a mating recess adapted to form a snap-fit attachment with the protruding lips of the container. The sides of the container can be sufficiently flexible to permit them to be pressed inwards to disengage the snap-fit attachment.

FIG. 1 is a schematic illustration of a trap 100 according to an embodiment of the invention.

The trap has a U-shaped section 102 adapted to fit between the racks of a bee hive.

The trap can have an elongate shape designed to fit between a pair of adjacent racks, preferably in an abutting relationship with the top rails of the racks.

The trap can include optional support means to support the trap proximate the top of the racks. The support means can include transverse projections 101, 103,105, 107, adapted to engage the top of a pair of adjacent racks.

Alternatively, the trap can include first engagement members adapted to engage with complementary engagement members on a cover. In the embodiment illustrated, the first engagement members are projecting lips 104, 106.

The trap can include one or more baffles 108, 110 dividing the base of the trap into two or more fluid compartments. A food grade oil can be poured into the base of the trap to assist in preventing beetles from leaving the trap. The baffles assist in maintaining the distribution of the fluid across the base of the trap.

FIG. 2 is a schematic illustration of a cover 200 adapted to be fitted to a trap such as that illustrated in FIG. 1.

The cover includes a central support beam 202 and a plurality of transverse “slats” 204.

The slats can be spaced apart by a distance 212 adapted to permit a small hive beetle to pass between the slats.

Preferably the slats are spaced to inhibit a bee from passing therebetween.

The slats can have a trapezoid section, as shown at exploded section 222, providing a wider opening between slats at the top than the bottom.

The length of the slats 214 can be such that they project beyond the edges of the trap and provide a support for the trap.

The cover can include second engagement members 206, 210, adapted to engage with the first engagement members 104, 106 of the trap. In the embodiment shown, the second engagement members 206, 210 are L-shaped members forming a ledge 208 adapted to provide a snap-fit with the first engagement members 104, 106 of the trap.

The cover can be sufficiently flexible to permit the snap-action engagement action with the projecting lips of the trap.

The cover can be removable to permit beetles to be removed from the trap.

FIG. 3 illustrates a trap 301 according to an embodiment of the invention with a cover fitted thereto. The lip 306 of the trap is shown in engagement with the ledge 308. The slats 304 are shown projecting beyond the edges of the trap. The width of the trap is such as to permit the trap to be inserted between a pair of racks, enabling the slats to engage the tops of the rails of the racks, as shown in FIG. 8. The spaces 312 formed between pairs of slats and the edge of the trap are sufficient to permit a beetle to crawl therethrough.

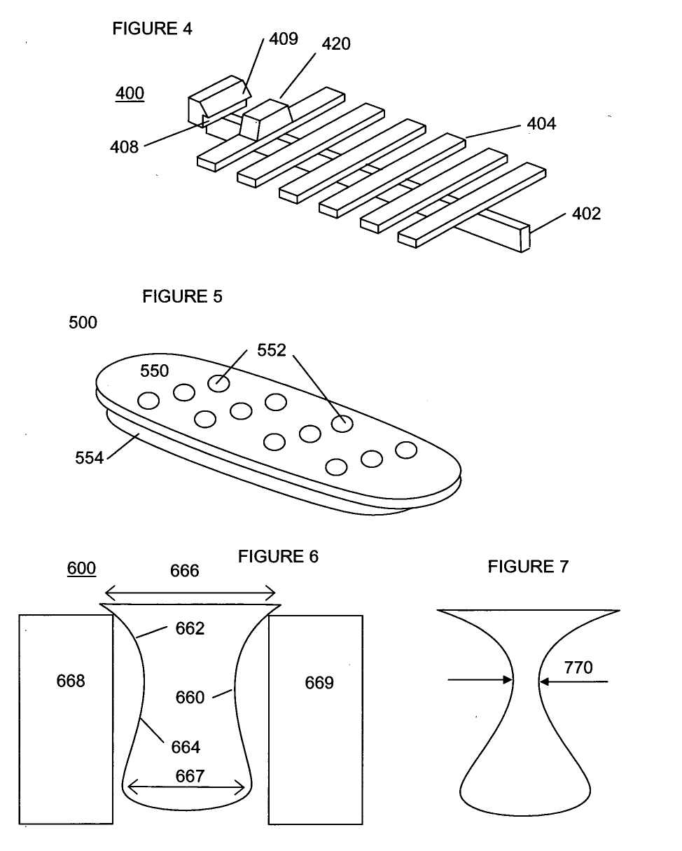

FIG. 4 is a partial view of the underside of the cover 200. The beam 402 carries the slats 404. The slats can be flush with the edge of the beam 402.

The snap-action engagement member can include a bevelled face 408 adapted to facilitate the connexion of the cover to the trap.

One or more projection members 420 are also provided on the underside of the cover 400. The projections 420 can be tapered to facilitate insertion and alignment of the cover in the trap. The projections 420 can be trapezoidal.

Preferably there is a projection 420 proximate each end of the cover.

The trap can be made of flexible material. The snap-action mechanism is such that squeezing the walls of the trap a short distance from the end will cause a snap-release action, with the cover releasing from engagement with the trap.

The projections 420 can be adapted to interact with the side walls of the trap when the walls are compressed to produce a separation force to disengage the snap-action connexion. FIG. 3 shows arrows 330, 332 where compressive force can be applied to the sides of the trap walls to cause the separating force. Preferably the compressive force is applied close to the tapered projections 420 and on the opposite side to the snap engagement elements 306, 308. For example, where the projection 420 is co-located with the first slat, pressure can be applied to the walls proximate the second slat. As the walls are compressed, they contact the tapered sides of the projections 420 and the reaction force includes a component tending to force the trap and the cover apart.

FIG. 5 shows an alternative cover 500 having a lid 550 with a plurality of through-holes 552 adapted to permit the beetle to pass therethrough. The lid is adapted to overhang the edges of the trap to support the trap between the racks. The lid has a projecting rim 554 adapted to be a press-fit in the top of the trap.

FIG. 6 illustrates an alternative cross-section for a trap 600. The cross-section can have a wider top rim 666 than the main portion of the trap so the top rim can support the trap between the racks 668, 669. The cross-section can have a profile so that the wall above the base portion is angled beyond the vertical, increasing the difficulty for the beetle to crawl out of the trap. The addition of oil in the trap further increases the difficulty of escape.

In a further embodiment shown in FIG. 7, the cross-section can be narrowed to a neck having a tight fit for the beetle to crawl through. Such a trap can be used without a cover.

The traps can be made of a dark material as the beetles prefer a dark environment.

The traps can be made of any suitable material such as metal or plastics.

In one embodiment, the trap has the following dimensions:
Trap
length 200 mm; height 25 mm; width 12 mm outside/10 mm inside;
Slats
length 28 mm; width 3 mm; depth 1.4 mm;
Beam
length 204 mm; depth 5 mm; width 2.5 mm.

FIG. 8 is a schematic illustration of a bee hive with the lid removed. The racks 884 are shown with a mat 886 covering a central portion of the tops racks. Only the outline of the mat is shown so the underlying features can be seen.

The slats 888 of a trap cover are shown bridging a pair of racks. One or more traps can be provided per hive.

The traps can run substantially the length of the rack, or can be shorter than the length of a rack. One or more traps can be used per hive.

The bees will harry the beetle which seek protection under the mat. The trap appears to offer a safer refuge.

The traps can be removed, emptied and reinserted after a few days.

In this specification, reference to a document, disclosure, or other publication or use is not an admission that the document, disclosure, publication or use forms part of the common general knowledge of the skilled worker in the field of this invention at the priority date of this specification, unless otherwise stated.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. An insect trap adapted to be supported between a pair of frames.

2. A trap as claimed in claim 1 in the form of a container closed on the bottom, sides and end walls.

3. A trap as claimed in claim 1, having one or more apertures adapted to permit a beetle to enter trap.

4. A trap as claimed in claim 1, wherein the container is adapted to be at least partially filled with a fluid.

5. A trap as claimed in claim 4, wherein the fluid is a food grade oil.

6. A trap as claimed in claim 5, wherein the oil can be filled into the container to cover the bottom of the container to a depth such that a beetle will be at least partially immersed.

7. A trap as claimed in claim 1, wherein one or more baffles are provided in the base of the container to divide the base of the container into two or more sections.

8. A trap as claimed in claim 1, including one or more apertures in the top or upper part of a side wall to provide an entry to the container.

9. A trap as claimed in claim 7, wherein the apertures are sufficiently small to deter the entry of bees to the container.

10. A trap as claimed in claim 1, wherein the container is an elongated U-shaped container.

11. A trap as claimed in claim 1, including a removable cover adapted to fit over the open upper end of the container.

12. A trap as claimed in claim 11, wherein the cover includes one or more apertures.

13. A trap as claimed in claim 11, wherein the cover includes a plurality of holes.

14. A trap as claimed in claim 11, wherein the cover is formed of an array of miniature slats connected to a support member.

15. A trap as claimed in claim 11, wherein the cover is a snap-fit with the container.

16. A trap as claimed in claim 1, wherein the container includes a protruding lip at either end.

17. A trap as claimed in claim 11, wherein the cover includes a mating recess adapted to form a snap-fit attachment with the protruding lips of the container.

18. A trap as claimed in claim 11, wherein the sides of the container are sufficiently flexible to permit them to be pressed inwards to disengage the snap-fit attachment.

19. A trap as claimed in claim 1, wherein the trap has an elongate shape designed to fit between a pair of adjacent racks, in an abutting relationship with the top rails of the racks.

20. A trap as claimed in claim 1, including support means to support the trap proximate the top of the racks.

21. A trap as claimed claim 1, including first engagement members adapted to engage with complementary second engagement members on a cover.

22. A trap as claimed claim 1, including one or more baffles dividing the base of the trap into two or more fluid compartments.

23. A trap as claimed in claim 1, adapted to trap small hive beetles.

24. A snap-action engagement mechanism including a pair of spaced apart substantially parallel opposed lips and a pair of spaced apart mating oppose recesses, at least one pair of the lips or recesses being resiliently mounted and adapted to create opposing latching forces when engaged with the mating pair of recesses or lips.

25. A snap-action engagement mechanism as claimed in claim 24, wherein the lips are formed on a first member, and the recesses are formed on a second member, the first member being compressible proximate the lips to disengage the snap-action connexion.

26. A snap-action engagement mechanism as claimed in claim 25, including a tapered member adapted to interact with the compressed walls of the first member to produce a separating force between the cover and the trap.

27. A trap as claimed in claim 1, including a cover attached by a snap-action engagement mechanism as claimed claim 24.

28. (canceled)

29. (canceled)
